(19) United States
(12) Patent Application Publication
(10) Pub. No.: US 2006/0188640 A1
(43) Pub. Date: Aug. 24, 2006

(54) Sazon Delsol with spanish olives

(76) Inventor: Orosman Delsol, Watertown, NY (US)

Correspondence Address: OROSMAN DELSOL, 440 PORTAGE STREET, WATERTOWN, NY, 13601, US

(21) Appl. No.: 11/028,874

(22) Filed: Feb. 24, 2005

(51) Int. Cl. A23L 1/221

(52) U.S. Cl. 426/650

(57) ABSTRACT

A seasoning comprises oregano, bay leaves, Spanish paprika, cumin, garlic, onion, Spanish olives, and culatro. The ingredients are separately dehydrated, then separately ground, and the ground ingredients are mixed. A method is taught for making the seasoning.

### BACKGROUND OF THE INVENTION

The present invention relates to a seasoning formulation. More particularly the invention relates to a seasoning formulation having a unique flavor which results from both a unique combination of ingredients, and a unique method of manufacture.

There are many types of seasonings available in the conventional marketplace, but many suffer from a variety of drawbacks. Some are made with artificial rather than natural ingredients. Some are heavy in salt and chemicals. Some are not really tasty. The present invention overcomes theses drawbacks, according to the teaching below.

### SUMMARY OF THE INVENTION

In an embodiment of the present invention a seasoning is provided, comprising: oregano, bay leaves, Spanish paprika, cumin, garlic, onion, Spanish olives, and culatro. In one embodiment the ingredients are separately dehydrated, then separately ground, and the ground ingredients are mixed.

In another aspect a method for preparing a seasoning is provided, comprising the steps of: (a) dehydrating and then grinding oregano; (b) dehydrating and then grinding bay leaves; (c) dehydrating and then grinding Spanish paprika; (d) dehydrating and then grinding cumin; (e) dehydrating and then grinding garlic; (f) dehydrating and then grinding onion; (g) dehydrating and then grinding Spanish olives; and (h) dehydrating and then grinding Culatro.

### BRIEF DESCRIPTION OF THE DRAWING FIGURES

FIG. 1 is a flow diagram illustrating the steps in manufacturing a seasoning according to an embodiment of the present invention.

### DESCRIPTION OF THE PREFERRED EMBODIMENTS

The present inventor has invented a unique seasoning he calls Sazon Delsol. Sazon is a Spanish word for “seasoning”, and Delsol is the inventors name. Sazon Delsol is made with Spanish olives and all natural ingredients with no salt or other chemicals added.

In a preferred embodiment Sazon Delsol comprises natural oregano, bay leaves (labural), Spanish Paprika, Cumin (cumino), garlic, onion, Spanish olives, and culatro.

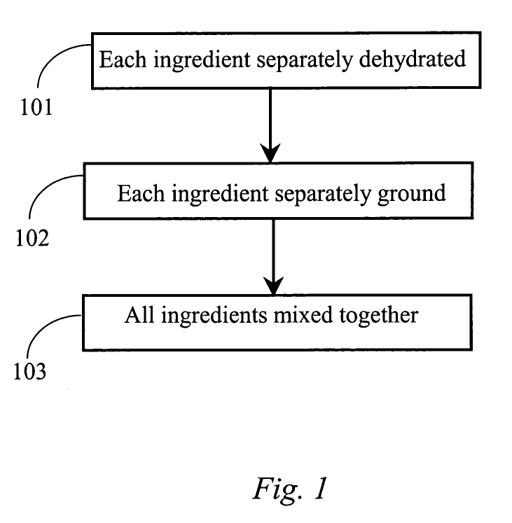

FIG. 1 is a flow diagram illustrating steps in preparation of Sazon Delsol in a preferred embodiment of the invention. In step 101 all of the ingredients, in one embodiment as listed above, are dehydrated separately. At step 102 each ingredient is separately ground. In step 3 all of the ingredients are mixed together to make the final product. There is no added salt or chemicals, and there are no hot or spicy ingredients in a preferred embodiment.

It will be appreciated by the skilled artisan that there may be other steps and ingredients without departing from the spirit and scope of the invention. Therefore the invention is to be limited only by the claims which follow:

I claim:

1. A seasoning, comprising:
oregano;
bay leaves;
Spanish paprika;
cumin;
garlic;
onion;
Spanish olives; and
culatro.

2. The seasoning of claim 1 wherein the ingredients are separately dehydrated, then separately ground, and the ground ingredients are mixed.

3. A method for making a seasoning, comprising the steps of:
(a) dehydrating and then grinding oregano;
(b) dehydrating and then grinding bay leaves;
(c) dehydrating and then grinding Spanish paprika;
(d) dehydrating and then grinding cumin;
(e) dehydrating and then grinding garlic;
(f) dehydrating and then grinding onion;
(g) dehydrating and then grinding Spanish olives; and
(h) dehydrating and then grinding Culatro.
